(19) United States
(12) Patent Application Publication
(10) Pub. No.: US 2002/0047949 A1
(43) Pub. Date: Apr. 25, 2002

(54) Liquid crystal displays

(76) Inventor: Steven C. Deane, Redhill (GB)

Correspondence Address: Corporate Patent Counsel, U.S. Philips Corporation, 580 White Plains Road, Tarrytown, NY, 10591, US

(21) Appl. No.: 09/932,084

(22) Filed: Aug. 17, 2001

(30) Foreign Application Priority Data
Aug. 22, 2000 (GB) 0020631.8

(51) Int. Cl. G02F 1/136

(52) U.S. Cl. 349/43

(57) ABSTRACT

A method of forming an active plate for a liquid crystal display using bottom gate TFTs. A black mask layer (50,52) is deposited over the patterned source and drain conductor layer before the semiconductor layer is patterned. The black mask layer (50,52) and the part of the semiconductor layer (19) not shielded by the patterned source and drain conductor layer are then patterned using the same pattern, thereby defining a transistor semiconductor body between the patterned gate conductor layer (10) and the patterned source and drain conductor layers (20,22,24) and also defining a patterned black mask layer (50) overlying the semiconductor body (19). In this method, a single mask can be used for patterning the black mask layer and the semiconductor layer defining the transistor body. In this way, no additional masks are required to provide shielding of the transistor body.

This invention relates to active matrix liquid crystal displays, and particularly to the transistor substrate, known as the active plate, used in the manufacture of such a display.

A liquid crystal display typically comprises an active plate and a passive plate between which liquid crystal material is sandwiched. The active plate comprises an array of transistor switching devices, typically with one transistor associated with each pixel of the display. Each pixel is also associated with a pixel electrode on the active plate to which a signal is applied for controlling the brightness of the individual pixel.

A large area of the active plate is at least partially transparent, and this is required because the display is typically illuminated by a back light. Mainly, the areas covered by the opaque row and column conductors are the only opaque parts of the plate. If the pixel electrode does not cover the transparent area, then there will be an area of liquid crystal material not modulated by the pixel electrode but which does receive light from the back light. This reduces the contrast of the display. A black mask layer is typically provided for shielding these areas of the active plate, and additionally to shield the transistors as their operating characteristics are light-dependent. Conventionally, the black mask layer is located on the passive plate of the active matrix cell. However, the overlap between the black mask layer and the pixel electrodes needs to be large in this case as a result of poor cell coupling accuracy. This overlap reduces the aperture of the display pixels, which reduces the power efficiency of the display. This is particularly undesirable for battery operated devices, such as portable products.

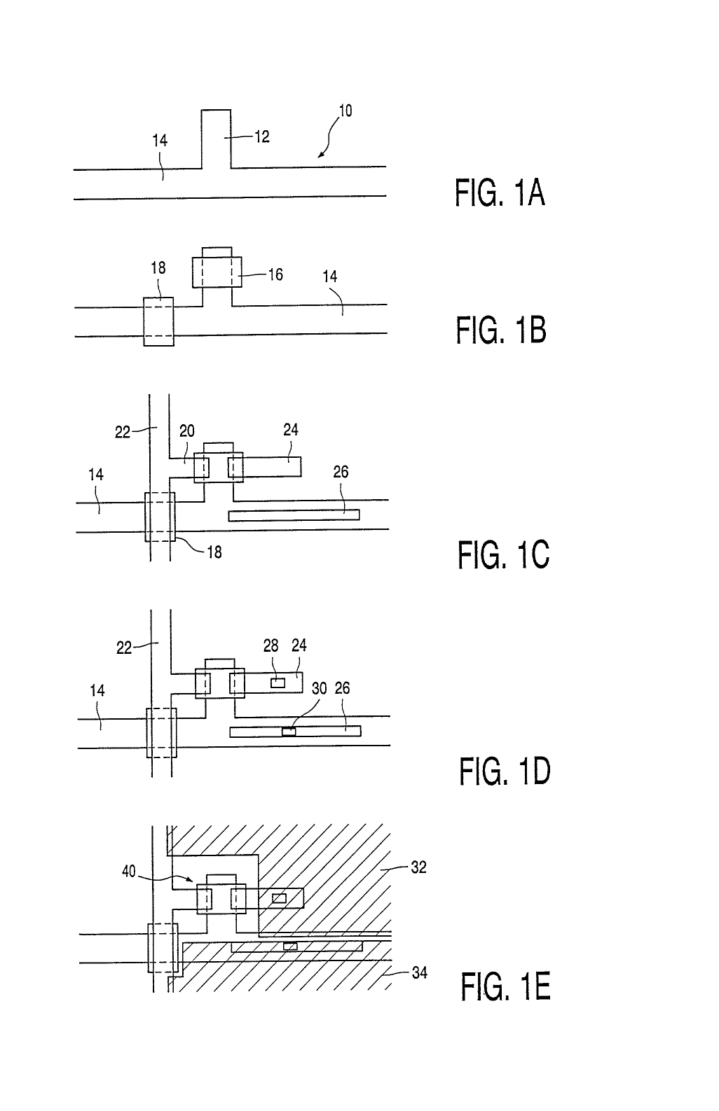

It has been proposed to use layers of the active plate to provide the required masking function. For example, one proposal is to define the pixel electrodes to overlap the row and column conductors, so that there is no gap between the row and column conductors and the pixel electrodes, which would otherwise need to be shielded. FIG. 1 illustrates the essential process steps for manufacturing an active plate in this way.

FIG. 1A shows a patterned gate conductor layer 10, which defines a transistor gate 12 which is connected to an associated row conductor 14. A gate insulator layer overlies the patterned gate conductor layer and a semiconductor layer is deposited over the insulated gate structure. The semiconductor layer is patterned to define the semiconductor body 16 of the transistor, as well as an insulator layer 18 to reduce capacitive coupling at the cross-over between row and column conductors. The patterned semiconductor layer 16,18 is shown in FIG. 1B.

A source and drain conductor layer is deposited and patterned over the silicon layer which defines a transistor source 20 connected to a column conductor 22, and a drain region 24. As shown in FIG. 1C, the region 18 provides insulation at the cross-over of the row 14 and column 22 conductors. The source and drain conductor layer also defines a capacitor top contact 26. This is a pixel charge storage capacitor defined by the row conductor 14, the gate insulator layer and the top contact 26.

As shown in FIG. 1D a passivation layer is deposited over the entire structure and through-holes 28, 30 are provided to enable connection through the passivation layer to the drain 24 and to the capacitor top contact 26. Finally, the pixel electrodes 32, 34 are deposited over the passivation layer with each pixel electrode making contact through the through-holes 28, 30 to a drain 24 of the associated switching transistor and to the top contact 26 of the pixel charged storage capacitor.

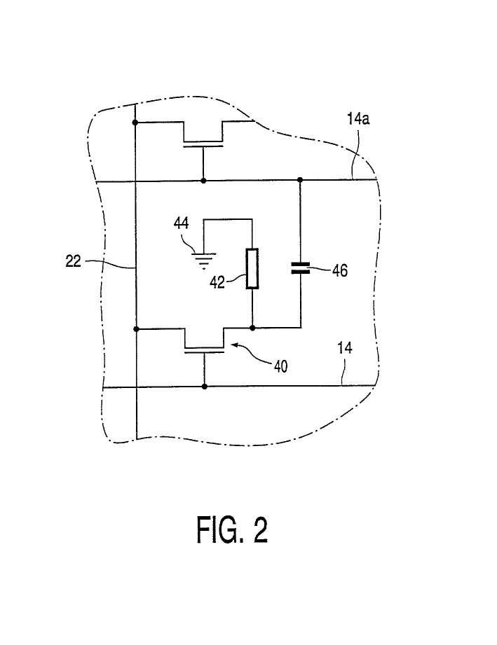

FIG. 2 shows the electrical components which make up the pixels shown in FIG. 1. The row conductor 14 is connected to the gate of the TFT 40, and the column electrode 22 is coupled to the source, as explained with reference to FIG. 1. The liquid crystal material provided over the pixel effectively defines a liquid crystal cell 42 which extends between the drain of the transistor 40 and a common ground plane 44. The pixel storage capacitor 46 is connected between the drain of the transistor 40 and the row conductor 14a associated with an adjacent row of pixels.

In the process described with reference to FIG. 1, the row and column electrodes are used to provide masking of the pixel. In particular, the overlap of the pixel electrodes 32 and 34 over the row and column conductors eliminates any gap which requires shielding. However, light must still be prevented from reaching the transistor in view of the photosensitivity of the transistor. Therefore, an organic black layer is also provided to cover the transistor region and prevent photo-induced leakage in it. This process allows the removal of the black mask from the passive plate, but requires an extra mask step for the active plate. This additional step is not shown in FIG. 1, but the mask may be provided on the active plate either beneath the passivation layer or else after formation of the pixel electrodes.

Although this method enables the black mask layer to be provided only on the active plate, which enables more accurate alignment, it increases the production cost of the display as a result of the increased mask steps.

According to the invention, there is provided a method of forming an active plate for a liquid crystal display, comprising:

depositing and patterning a gate conductor layer over an insulating substrate;

depositing a gate insulator layer over the patterned gate conductor layer;

depositing a silicon layer over the gate insulator layer;

depositing and patterning a source and drain conductor layer over the silicon layer;

depositing a black mask layer over the patterned source and drain conductor layer;

patterning the black mask layer and patterning the part of the semiconductor layer not shielded by the patterned source and drain conductor layer using the same pattern, thereby defining a transistor semiconductor body between the patterned gate conductor layer and the patterned source and drain conductor layers and also defining a patterned black mask layer overlying the semiconductor body; and

forming a pixel electrode layer for contacting one of the source and drain of the transistor.

In this method, a single mask can be used for patterning the black mask layer and the semiconductor layer defining the transistor body. In this way, no additional masks are required to provide shielding of the transistor body.

Preferably, the black mask layer is patterned by a first process, and the part of the semiconductor layer not shielded by the patterned source and drain conductor layer is patterned by a second process using the patterned black mask layer as an etching mask.

Preferably, a passivation layer is provided between the patterned black mask layer and the pixel electrode layer, a through hole being provided in the passivation layer to enable contact between the pixel electrode layer and the one of the source and drain of the transistor. This passivation layer is preferably sufficiently thick to enable the pixel electrodes to partially overlap row and column conductors so that pixel electrodes each occupy a pixel space bordered by the row and column conductors and which partially overlap those row and column conductors. As a result, all of the liquid crystal material exposed to light through the substrate is modulated by the pixel electrode, so that no shielding of liquid crystal material is required. Therefore, the black mask layer patterned to coincide with the silicon layer provides all the required shielding.

The invention also provides an active plate for a liquid crystal display, comprising:

a gate conductor layer over an insulating substrate defining gate conductors for pixel transistors and also defining row conductors;

a gate insulator layer over the gate conductor layer;

a silicon layer over the gate insulator layer and defining a transistor body region overlying the gate conductors;

a source and drain conductor layer over the silicon layer defining source and drain conductors for the pixel transistors and also defining column conductors each connected to one of the source and drain of an associated transistor, the silicon layer lying beneath the source and drain conductor layer at all locations of the source and drain conductor layer;

a black mask layer over the source and drain conductor layer and having a portion corresponding in shape and aligned with the transistor body region of the silicon layer; and

a pixel electrode layer defining pixel electrodes which contact the other of the source and drain of the associated transistor.

This active plate may be used to form an active matrix liquid crystal display in which a layer of liquid crystal material is sandwiched between the active plate and a passage plate.

An example of the invention will now be described in detail with reference to the accompanying drawings, in which:

FIG. 1 illustrates a known method of producing an active plate for an active matrix liquid crystal display;

FIG. 2 shows the electrical equivalent circuit of one pixel of the display;

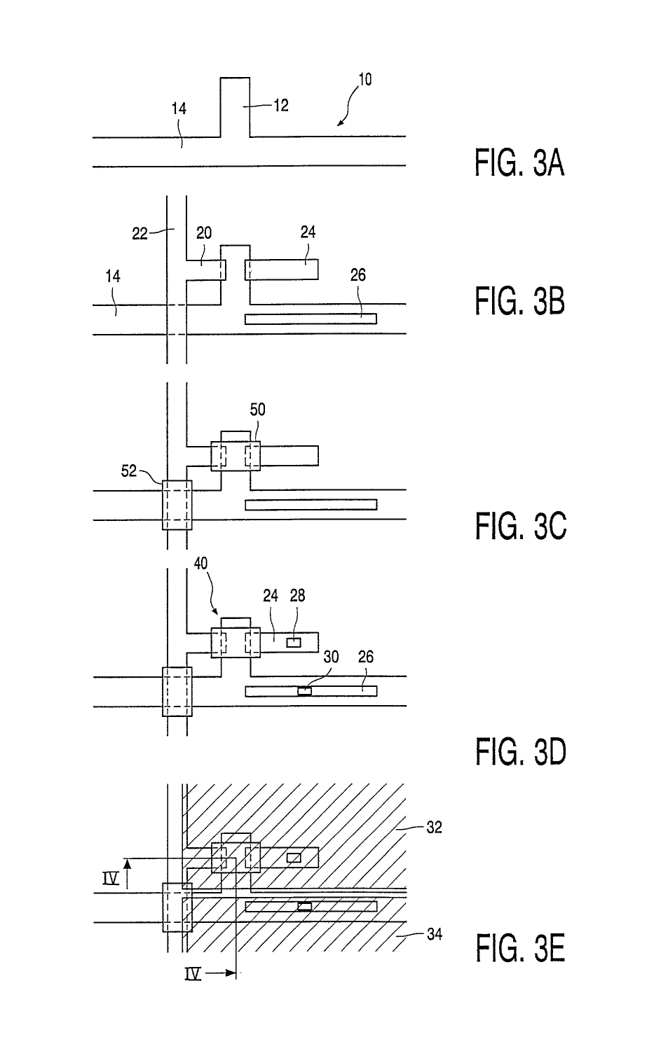

FIG. 3 shows a process for manufacturing an active plate in accordance with the invention;

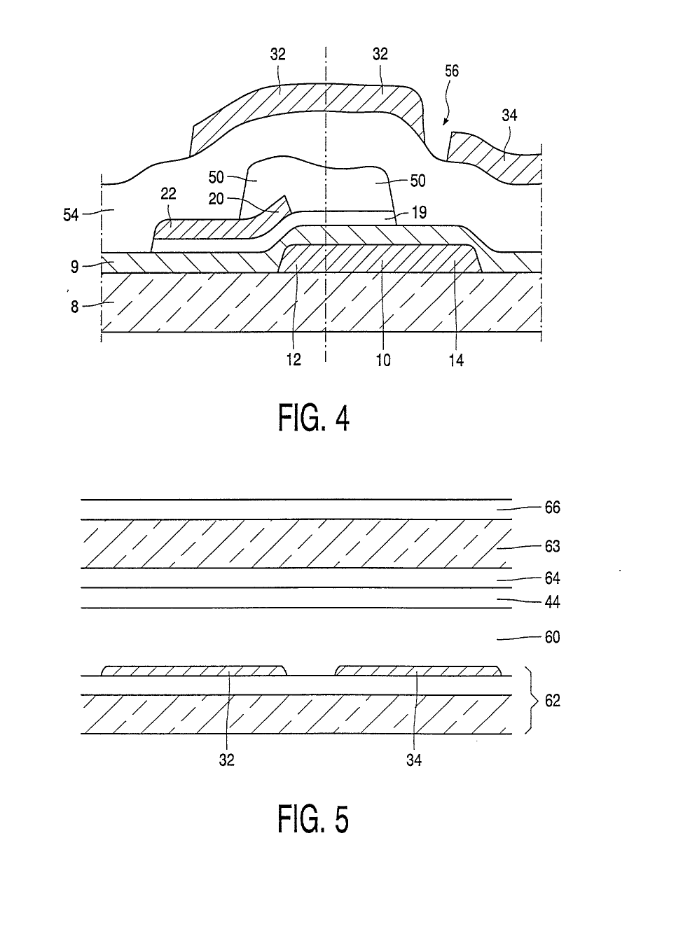

FIG. 4 shows the cross-section iv-iv of FIG. 3E; and

FIG. 5 shows an active matrix liquid crystal display using an active plate of the invention.

It should be noted that the figures are diagrammatic and not drawn to scale. Relative dimensions and proportions of parts of these figures have been shown exaggerated or reduced in size, for the sake of clarity and convenience in the drawings.

FIG. 3 is used to explain the process of the invention. FIG. 3A corresponds to FIG. 1A and shows a gate conductor layer 10 deposited over an insulating substrate and patterned to define a transistor gate and an associated row conductor 14. As will be apparent from the following description, the gate conductor layer 10 comprises an opaque material, for example chromium. Patterning to achieve the layout shown in FIG. 3A is then achieved using a wet etching technique. A gate insulator layer is provided over the entire substrate overlying the gate conductor layer 10. This gate insulator layer may be a single layer of, for example, silicon nitride or else it may comprise a multiple-layer structure.

A silicon layer, for example hydrogenated amorphous silicon, is deposited over the gate insulator layer overlying the entire substrate. A doped n⁺ silicon contact layer is also deposited over the amorphous silicon layer. This completes the structure shown in FIG. 3A, although the gate insulator layer and the silicon layer are not shown.

A source and drain conductor layer is deposited and patterned over the silicon layer to provide the structure shown in FIG. 3B. This source and drain conductor layer defines the transistor source 20 coupled to an associated column conductor 22, the transistor drain 24 and a storage capacitor top contact 26. The material of the source and drain conductor layer is also opaque and may again comprise chromium. At this stage, the semiconductor layers (the transistor body layer and the doped contact layer) still remain unpatterned and covers the entire substrate beneath the source and drain conductor layer. Accordingly, the etchant used in the patterning of the source and drain conductor layer leaves the semiconductor layer unaffected.

A black mask layer is then provided over the entire substrate. Preferably an organic black layer is used, for example a light-sensitive black resin which is coated, exposed and developed to form the black layer.

The black layer is patterned to define regions 50 and 52, shown in FIG. 3C. Region 50 corresponds to the desired layout of the transistor semiconductor body, and region 52 is used to prevent etching of the layers between the row and column conductors at the vicinity of the cross-over. This will become apparent from the additional steps described below. The black layer is patterned by a first process to define the regions 50, 52. Subsequently, the patterned black mask layer is used as an etching mask for a second etching process by which the semiconductor layer is patterned. This second process uses an etchant which does not attack the source and drain electrode pattern 20, 22, 24, 26 so that the semiconductor layers are removed from regions not shielded by the source and drain conductor layer or by the patterned black mask layer. This second process may or may not remove the gate insulator layer, but in any event leaves the gate conductor layer intact.

A passivation layer is deposited over the resulting structure and as shown in FIG. 3D through-holes 28 and 30 are patterned into the passivation layer to enable contact to the transistor drain 24 and to the capacitor top contact 26.

Finally, a pixel electrode layer is deposited over the structure, and is patterned to define an individual pixel electrode for each pixel of the display. Each pixel electrode contacts the transistor drain 24 through the through-hole 28 and also contacts the capacitor top contact 26 through the through-hole 30. Each pixel electrode 32, 34 fills the pixel space defined by adjacent row and column conductors. In particular, each pixel electrode 32, 34 partially overlaps the row and column conductors which border that particular pixel. In the liquid crystal display device, liquid crystal material overlies the structure shown in FIG. 3E, and the liquid crystal material modulates light received from a back light on the opposite side of the substrate. As the row and column conductors are opaque, all liquid crystal material receiving light through the substrate (namely all areas not shielded by opaque parts of the structure) is modulated by a pixel electrode. This means that no additional black mask layer is required. The region 50 of the black mask layer shields the transistor semiconductor body. The material of the pixel electrode is transparent, to allow light from the back light to reach the liquid crystal material. For example, the pixel electrodes may be formed from ITO.

As the pixel electrode 32 overlies the transistor structure, the passivation layer needs to have sufficient thickness or dielectric constant to prevent capacitive coupling between the signal on the pixel electrode and the underlying components of the active plate. For example, the passivation layer may comprise polyimide.

The invention enables a black mask layer to be formed on the active plate without requiring additional mask layers, and which avoids the need for a black mask layer on the passive plate of the liquid crystal display. Each part of FIG. 3 corresponds to one of the masks required to manufacture the active plate. It can therefore be seen that a five-mask process is required, whereas the prior art of FIG. 1 requires an additional mask step to define the black mask layer.

FIG. 4 shows a cross-section along the line IV-IV in FIG. 3E. The left part of FIG. 4 is in the vicinity of the source electrode 20. As shown, the layers comprise the substrate 8, the gate conductor layer 10 which defines the gate electrode 12 and with the overlying gate insulator layer 9. In the example shown in FIG. 4, the gate insulator layer remains unpatterned. In other words, the etching of the silicon layer in FIG. 3D, using the patterned black mask layer as an etch mask, removes only the silicon layer and not the underlying gate insulator layer.

The patterned silicon layer 19 is provided over the gate insulator layer 9. As described above, this layer 19 extends beyond the transistor region 40, because the silicon layer also lies beneath the source and drain conductor layer 20, 22, 24 at all locations of the source and drain conductor layer. As shown in FIG. 4, the left part of the source and drain conductor layer defines the column conductor 22, and the right part of this layer defines the source electrode 20.

The region 50 of the black mask layer overlaps the source electrode 20 and covers the part of the semiconductor layer 19 defining the transistor body. The passivation layer 54 separates the pixel electrode 32 from the components of the transistor.

The right hand portion of FIG. 4 illustrates the structure over the gate conductor 12. In this part of the structure, the black mask layer 50 is used as an etch mask in the patterning of the semiconductor layer 19. The right hand portion of the gate conductor layer 10 comprises the row electrode 14, and as shown the pixel electrodes 32 and 34 for pixels on opposite sides of the row conductor 14 each overlap the row conductor 14. Although not shown, the same situation arises in connection with the column conductors 22. The spacing 56 between pixel electrodes represents the part of the liquid crystal material which is not modulated by the pixel electrodes. This space 56 overlies an opaque row or column conductor, so that no black mask layer is required in this respect.

FIG. 5 shows the structure of a complete liquid crystal display. A layer of liquid crystal material 60 is provided over the active plate 62, which comprises the structure described above. A further substrate 63 overlies the layer of liquid crystal material. This further substrate 63 may be provided on one face with an arrangement of colour filters 64 and a plate defining the common electrode 44 (shown in FIG. 2). A polarizing plate 66 is also provided on the opposite side of the substrate 63.

As this invention is concerned specifically with the transistor substrate, the operation and construction of the liquid crystal display will not be described in any further detail as this will be apparent to those skilled in the art.

In the example described, a storage capacitor is defined using an adjacent row conductor. Instead, a separate storage capacitor line may be provided.

Additional layers to those described may be provided, and there are various alternatives which will be apparent to those skilled in the art. The specific processing parameters and materials have not been described in detail in this application, as this invention relies upon known individual processing steps and materials. The steps, and the range of possible alternatives, will be apparent to those skilled in the art.

1. A method of forming an active plate for a liquid crystal display, comprising:
depositing and patterning a gate conductor layer over an insulating substrate;
depositing a gate insulator layer over the patterned gate conductor layer;
depositing a silicon layer over the gate insulator layer;
depositing and patterning a source and drain conductor layer over the silicon layer;
depositing a black mask layer over the patterned source and drain conductor layer;
patterning the black mask layer and patterning the part of the semiconductor layer not shielded by the patterned source and drain conductor layer using the same pattern, thereby defining a transistor semiconductor body between the patterned gate conductor layer and the patterned source and drain conductor layers and also defining a patterned black mask layer overlying the semiconductor body; and
forming a pixel electrode layer for contacting one of the source and drain of the transistor.

2. A method as claimed in claim 1, wherein the black mask layer is patterned by a first process, and the part of the semiconductor layer not shielded by the patterned source and drain conductor layer is patterned by a second process using the patterned black mask layer as an etching mask.

3. A method as claimed in claim 2, wherein the source and drain conductor layer is substantially insensitive to the etchant used in the second process.

4. A method as claimed in any preceding claim, wherein a passivation layer is provided between the patterned black mask layer and the pixel electrode layer, a through hole being provided in the passivation layer to enable contact between the pixel electrode layer and the one of the source and drain of the transistor.

5. A method as claimed in claim 4, wherein the gate conductor layer defines row conductors and the source and drain conductor layer defines column conductors and wherein the pixel electrode layer defines pixel electrodes which each occupy a pixel space bordered by row and column conductors and which partially overlap those row and column conductors.

6. An active plate for a liquid crystal display, comprising:
a gate conductor layer over an insulating substrate defining gate conductors for pixel transistors and also defining row conductors;
a gate insulator layer over the gate conductor layer;
a silicon layer over the gate insulator layer and defining a transistor body region overlying the gate conductors;
a source and drain conductor layer over the silicon layer defining source and drain conductors for the pixel transistors and also defining column conductors each connected to one of the source and drain of an associated transistor, the silicon layer lying beneath the source and drain conductor layer at all locations of the source and drain conductor layer;
a black mask layer over the source and drain conductor layer and having a portion corresponding in shape and aligned with the transistor body region of the silicon layer; and
a pixel electrode layer defining pixel electrodes which contact the other of the source and drain of the associated transistor.

7. An active plate for a liquid crystal display as claimed in claim 6, wherein the pixel electrodes contact the other of the source and drain of the associated transistor though a via in a passivation layer between the pixel electrode layer and the black mask layer.

8. An active plate for a liquid crystal display as claimed in claim 6 or 7, wherein the pixel electrodes each occupy a pixel space bordered by row and column conductors, and the pixel electrodes partially overlap those row and column conductors.

9. An active matrix liquid crystal display comprising an active plate as claimed in any one of claims 6 to 8, a passive plate, and a layer of liquid crystal material sandwiched between the active and passive plates.
